(19) United States
(12) Patent Application Publication
(10) Pub. No.: US 2006/0130012 A1
(43) Pub. Date: Jun. 15, 2006

(54) Program conversion device, program conversion and execution device, program conversion method, and program conversion and execution method

(75) Inventors: Fumihiro Hatano, Takatsuki-shi (JP); Akira Tanaka, Hirakata-shi (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/269,705

(22) Filed: Nov. 9, 2005

(30) Foreign Application Priority Data
Nov. 25, 2004 (JP) 2004-341236

(51) Int. Cl. G06F 9/45

(52) U.S. Cl. 717/136; 717/140

(57) ABSTRACT

To provide a compiler device that generates an executable program for a computer capable of executing two or more instructions in parallel, without using compensation code in trace scheduling. The compiler device generates the executable program that causes the computer to concurrently execute code which is a substantially direct translation of the source program, and code generated by optimizing a sequence of instructions of a most frequent execution path in the source program.

### BACKGROUND OF THE INVENTION

1. Field of the Invention

The present invention relates to optimization of a program by a compiler, and particularly relates to optimization based on an execution frequency of an execution path in a program.

2. Related Art

Various efforts have been directed at developing compilers that convert a source program to an executable program which runs faster on target hardware.

To increase an execution speed of an executable program, a compiler device performs instruction scheduling. Instruction scheduling includes global scheduling that reorders instructions in a program to enhance instruction-level parallelism, thereby achieving faster execution. Trace scheduling is one of such global scheduling methods. Here, a sequence of instructions in a program that include no conditional branch in a middle and are therefore consecutively executed, though it may contain a conditional branch at an end, is called a basic block. Conventionally, instructions in basic blocks are reordered to enhance instruction-level parallelism, so as to reduce an execution time of an executable program.

According to trace scheduling, a basic block having a conditional branch at its end is connected with one of branch target basic blocks as if the conditional branch does not exist, to create an extended basic block. Having done so, instruction scheduling is performed by reordering instructions in the extended basic block.

Since the original basic blocks are extended, instruction scheduling can be performed more flexibly, with it being possible to further reduce the execution time of the executable program. In actual execution of the executable program, however, control may not take an execution path of such an extended basic block. In view of this, compensation code needs to be provided in order to maintain the value consistency in the program. When control takes the execution path of the extended basic block which has undergone optimization, the executable program runs faster than an executable program that is a substantially direct translation of a source program without trace scheduling. These scheduling techniques are disclosed in Japanese Patent Application Publication No. H11-96005.

Basically, the above basic block extension is applied to basic blocks which lie in frequently executed paths of a program.

A specific example of trace scheduling is given below. FIG. 20A is a control flow graph showing one part of a source program having branches as illustrated. Suppose an execution path connecting basic blocks A 2001, B 2002, and C 2003 has a highest execution frequency. Applying trace scheduling to this part of the source program according to execution frequency yields, for example, an outcome shown in FIG. 20B. In extended basic block 2010, basic blocks A 2001 and B 2002 have been interchanged on the ground that this order contributes to faster execution. When control takes an execution path of this extended basic block 2010, i.e. a sequence of basic blocks B 2012, A 2011, and C 2013, the overall execution time decreases.

As mentioned earlier, trace scheduling reorders instructions in basic blocks, so that compensation code needs to be provided to maintain the value consistency in the case where control takes another execution path.

Basic block A′ 2018 in FIG. 20B serves as such compensation code. In FIG. 20B, if the program is branched from basic block B 2012 directly to basic block D 2004 as in FIG. 20A, an operation of basic block A 2001 will end up being missing. This being so, basic block A′ 2018 is inserted as compensation code corresponding to basic block A 2001, in order to maintain the value consistency for an execution path connecting basic blocks A 2001, B 2002, D 2004, and E 2005 in FIG. 20A.

If a program includes more complex conditional branches, compensation code becomes more complex. In some cases, when control takes an execution path including compensation code, the program may run slower than expected. Thus, the provision of compensation code can result in an increase in overall execution time.

### SUMMARY OF THE INVENTION

To solve the above problems, the present invention aims to provide a program conversion device for generating a program by forming an extended basic block in a specific execution path and optimizing the extended basic block without using compensation code.

The stated aim can be achieved by a program conversion device for converting a source program including a conditional branch into an object program for a computer that is capable of executing at least two instructions in parallel, including: an execution path specifying unit operable to specify an execution path out of a plurality of execution paths in one section of the source program, the section containing the conditional branch and a plurality of branch targets of the conditional branch; a first code generating unit operable to generate first code corresponding to all instructions in the section; a second code generating unit operable to generate second code corresponding to a sequence of instructions in the specified execution path, the second code including, as code corresponding to the conditional branch, code that indicates to continue to an instruction which follows the conditional branch in the sequence if a condition for taking the execution path is true, and stop continuing to the instruction if the condition is false; a third code generating unit operable to generate third code corresponding to instructions in a succeeding section of the source program; and an object program generating unit operable to generate an object program which causes the computer to execute the first code and the second code in parallel, and execute the third code after the second code if the condition is true and after the first code if the condition is false.

The term “corresponding to” used here means code has substantially same contents as instructions in the source program. It should be noted however that registers to be accessed change depending on a memory type of the computer. Also, an execution path means a sequence of instructions which are consecutively executed. When a program branches at a conditional branch, an execution path corresponds to a single one of a plurality of branch targets of that conditional branch. The object program generated by the object program generating unit may be intermediate code or an executable program that is ready to run on the computer. The intermediate code means code that is generated during a process of converting the source program into the executable program so as to ease handling of code by the program conversion de vice, and has the contents corresponds to the source program.

According to the above construction, the object program causes one processor element in the computer to execute the first code which is a substantially direct translation of the source program without optimization, and another processor element in the computer to execute the second code which is generated by optimizing the sequence of instructions in the specified execution path.

In this way, the program which has been optimized with regard to the specified execution path can be generated without using compensation code that is conventionally needed to maintain the value consistency when control takes another execution path. Also, when control takes the specified execution path, the second code runs faster than the first code, which speeds up the start of the third code. As a result, the overall execution time is reduced. Furthermore, the value consistency can be maintained since the first processor element executes the first code corresponding to the original source program.

Here, the object program generating unit may generate the object program which further causes the computer to stop executing the second code when the first code ends earlier than the second code.

According to this construction, the object program is organized to cause, when the first code ends earlier than the second code, the processor element executing the second code to stop the execution, and then assign another thread to that processor element. This contributes to effective resource utilization.

Here, the program conversion device may further include an execution path obtaining unit operable to obtain, from the computer, information showing an execution path most frequently taken in the section as a result of the computer executing a program which is a substantially direct translation of the source program, wherein the execution path specifying unit specifies the most frequent execution path.

According to this construction, the sequence of instructions in the most frequent execution path is optimized. Therefore, when control takes this execution path, the execution time of the program can be reduced.

Here, the program conversion device may further include a parallel execution limit obtaining unit operable to obtain a number m, the number m being a number of instructions executable in parallel by the computer, wherein the execution path obtaining unit further obtains, from the computer, information showing execution paths second most to least frequently taken in the section, the execution path specifying unit further specifies, based on the number m, second to nth most frequent execution paths where n=m−1, the second code generating unit generates n sets of second code corresponding one-to-one to the most to nth most frequent execution paths specified by the execution path specifying unit, and the object program generating unit generates the object program which causes the computer to execute the first code and the n sets of second code separately, in parallel.

According to this construction, two or more execution paths having high execution frequencies can be executed as separate threads, with it being possible to reduce the overall execution time.

Here, the object program generating unit may generate the object program which further causes the computer to stop the n sets of second code other than a set of second code for which a condition for taking a corresponding execution path is true.

According to this construction, the object program is organized to cause, when control takes an execution path, a processor element executing a thread of that execution path, to stop other threads.

Here, the object program generating unit may generate the object program which causes the computer to retain any of the stopped sets of second code without deleting.

According to this construction, when the next thread is the same as the current thread and differs only in operation data, only the operation data needs to be passed to the processor element since the current thread is retained. This saves a trouble of passing the thread and operation data to the processor element each time, with it being possible to reduce the execution time of the program.

Here, the program conversion device may further include a memory information obtaining unit operable to obtain memory information showing whether the computer is of a memory sharing type where all processor elements in the computer share one memory, or a memory distribution type where the processor elements each have an individual memory, wherein if the memory information shows the memory sharing type, the object program generating unit generates the object program which further causes processor elements respectively executing the first code and the second code to separately treat a same variable.

To separately treat a same variable means, when the first code and the second code reference a same variable in the source program, the processor element executing the first code and the processor element executing the second code store the variable in different registers.

According to this construction, results of operations carried out according to the program can be ensured in the computer of the memory sharing type.

Here, the program conversion device may further include a machine language converting unit operable to convert the object program into a machine language applicable to the computer.

According to this construction, if the object program is intermediate code, the intermediate code can further be converted to an executable program that is written in a machine language applicable to the computer.

The stated aim can also be achieved by a program conversion and execution device for converting a source program including a conditional branch into an object program, the program conversion and execution device being capable of executing at least two instructions in parallel, and including: an execution path specifying unit operable to specify an execution path out of a plurality of execution paths in one section of the source program, the section containing the conditional branch and a plurality of branch targets of the conditional branch; a first code generating unit operable to generate first code corresponding to all instructions in the section; an executing unit operable to execute a program which is a substantially direct translation of the source program, the program including the first code; an obtaining unit operable to obtain information showing an execution path most frequently taken in the section as a result of the executing unit executing the program, wherein the execution path specifying unit specifies the most frequent execution path; a second code generating unit operable to generate second code corresponding to a sequence of instructions in the specified execution path, the second code including, as code corresponding to the conditional branch, code that indicates to continue to an instruction which follows the conditional branch in the sequence if a condition for taking the execution path is true, and stop continuing to the instruction if the condition is false; a third code generating unit operable to generate third code corresponding to instructions in a succeeding section of the source program; and an object program generating unit operable to generate an object program which causes the executing unit to execute the first code and the second code in parallel, and execute the third code after the second code if the condition is true and after the first code if the condition is false, wherein the executing unit executes the object program.

According to this construction, the program conversion and execution device capable of executing a program while generating it can produce a program which runs faster when control takes a frequent execution path.

As noted earlier, a more complex control flow graph requires more complex compensation code. In a compiler device that employs just-in-time compilation, that is, dynamic translation, to enhance execution performance of part of code in an interpreter which analyzes and executes each line of code in succession, generation of such compensation code would result in a loss of time. According to the present invention, this problem will not arise since there is no need to generate compensation code.

Here, the object program generating unit may generate the object program which further causes the executing unit to stop executing the second code when the first code ends earlier than the second code.

According to this construction, the object program is organized to cause, when the first code ends earlier than the second code, a processor element executing the second code to stop the execution, and then assign another thread to that processor element. This contributes to effective resource utilization.

Here, the program conversion and execution device may further include a parallel execution limit obtaining unit operable to obtain a number m, the number m being a number of instructions executable in parallel by the program conversion and execution device, wherein the execution path obtaining unit further obtains information showing execution paths second most to least frequently taken in the section, the execution path specifying unit further specifies, based on the number m, second to nth most frequent execution paths where n=m−1, the second code generating unit generates n sets of second code corresponding one-to-one to the most to nth most frequent execution paths specified by the execution path specifying unit, and the object program generating unit generates the object program which causes the executing unit to execute the first code and the n sets of second code separately, in parallel.

According to this construction, two or more execution paths having high execution frequencies can be executed as separate threads, with it being possible to reduce the overall execution time.

Here, the object program generating unit may generate the object program which further causes the executing unit to stop the n sets of second code other than a set of second code for which a condition for taking a corresponding execution path is true.

According to this construction, the object program is organized to cause, when a condition for executing one thread is true, other processor elements to stop executing other threads, and then assign next threads to those processor elements. This contributes to effective resource utilization.

Here, the object program generating unit may generate the object program which causes the executing unit to retain any of the stopped sets of second code without deleting.

According to this construction, when the next thread is the same as the current thread and differs only in operation data, only the operation data needs to be passed to the corresponding processor element since the current thread is retained. This saves a trouble of passing the thread and operation data to the processor element each time, with it being possible to reduce the execution time of the program.

Here, the object program generating unit may generate the object program which further causes processor elements respectively executing the first code and the second code to separately treat a same variable, if a memory type of the program conversion and execution device is of a memory sharing type where all processor elements in the program conversion and execution device share one memory.

According to this construction, the object program is organized to appropriately assign values to registers depending on whether the program conversion and execution device is of the memory sharing type or the memory distribution type.

The stated aim can also be achieved by a program conversion method for converting a source program including a conditional branch into an object program for a computer that is capable of executing at least two instructions in parallel, including: an execution path specifying step of specifying an execution path out of a plurality of execution paths in one section of the source program, the section containing the conditional branch and a plurality of branch targets of the conditional branch; a first code generating step of generating first code corresponding to all instructions in the section; a second code generating step of generating second code corresponding to a sequence of instructions in the specified execution path, the second code including, as code corresponding to the conditional branch, code that indicates to continue to an instruction which follows the conditional branch in the sequence if a condition for taking the execution path is true, and stop continuing to the instruction if the condition is false; a third code generating step of generating third code corresponding to instructions in a succeeding section of the source program; and an object program generating step of generating an object program which causes the computer to execute the first code and the second code in parallel, and execute the third code after the second code if the condition is true and after the first code if the condition is false.

According to this method, the object program for parallel execution of the first code and the second code which is generated by optimizing the specified execution path can be generated.

Here, the object program generating step may generate the object program which further causes the computer to stop executing the second code when the first code ends earlier than the second code.

According to this method, the object program is organized to cause, when the first code ends earlier than the second code, a processor element executing the second code to stop the execution.

Here, the program conversion method may further include an execution path obtaining step of obtaining, from the computer, information showing an execution path most frequently taken in the section as a result of the computer executing a program which is a substantially direct translation of the source program, wherein the execution path specifying step specifies the most frequent execution path.

According to this method, the object program is organized for parallel execution of the first code and the second code which is obtained by optimizing the instructions in the most frequent execution path.

Here, the program conversion method may further include a parallel execution limit obtaining step of obtaining a number m, the number m being a number of instructions executable in parallel by the computer, wherein the execution path obtaining step further obtains, from the computer, information showing execution paths second most to least frequently taken in the section, the execution path specifying step further specifies, based on the number m, second to nth most frequent execution paths where n=m−1, the second code generating step generates n sets of second code corresponding one-to-one to the most to nth most frequent execution paths specified in the execution path specifying step, and the object program generating step generates the object program which causes the computer to execute the first code and the n sets of second code separately, in parallel.

According to this method, the object program is organized for parallel execution of the first code and the plurality of sets of second code generated by optimizing the plurality of frequent execution paths.

Here, the object program generating step may generate the object program which further causes the computer to stop the n sets of second code other than a set of second code for which a condition for taking a corresponding execution path is true.

According to this method, the object program is organized to cause, when control takes an execution path, a processor element executing a thread of that execution path, to stop other threads.

Here, the object program generating step may generate the object program which causes the computer to retain any of the stopped sets of second code without deleting.

According to this method, the object program with which a thread can be retained for further use can be generated.

Here, the program conversion method may further include a memory information obtaining step of obtaining memory information showing whether the computer is of a memory sharing type where all processor elements in the computer share one memory, or a memory distribution type where the processor elements each have an individual memory, wherein if the memory information shows the memory sharing type, the object program generating step generates the object program which further causes processor elements respectively executing the first code and the second code to separately treat a same variable.

According to this method, results of operations carried out according to the program can be ensured in the computer of the memory sharing type.

Here, the program conversion method may further include a machine language converting step of converting the object program into a machine language applicable to the computer.

According to this method, if the object program is intermediate code, the intermediate code can further be converted to an executable program that is written in a machine language applicable to the computer.

The stated aim can also be achieved by a program conversion and execution method used in a program conversion and execution device for converting a source program including a conditional branch into an object program, the program conversion and execution device being capable of executing at least two instructions in parallel, including: an execution path specifying step of specifying an execution path out of a plurality of execution paths in one section of the source program, the section containing the conditional branch and a plurality of branch targets of the conditional branch; a first code generating step of generating first code corresponding to all instructions in the section; an executing step of executing a program which is a substantially direct translation of the source program, the program including the first code; an obtaining step of obtaining information showing an execution path most frequently taken in the section as a result of executing the program, wherein the execution path specifying step specifies the most frequent execution path; a second code generating step of generating second code corresponding to a sequence of instructions in the specified execution path, the second code including, as code corresponding to the conditional branch, code that indicates to continue to an instruction which follows the conditional branch in the sequence if a condition for taking the execution path is true, and stop continuing to the instruction if the condition is false; a third code generating step of generating third code corresponding to instructions in a succeeding section of the source program; and an object program generating step of generating an object program which causes execution of the first code and the second code in parallel, and execution of the third code after the second code if the condition is true and after the first code if the condition is false, wherein the executing step executes the object program.

According to this method, the object program for parallel execution of the first code and the second code which is obtained by optimizing the-most frequent execution path can be generated during runtime.

Here, the object program generating step may generate the object program which further causes stopping of the execution of the second code when the first code ends earlier than the second code.

According to this method, the object program is organized to cause, when the first code ends earlier than the second code, a processor element executing the second code to stop the execution.

Here, the program conversion and execution method may further include a parallel execution limit obtaining step of obtaining a number m, the number m being a number of instructions executable in parallel by the program conversion and execution device, wherein the execution path obtaining step further obtains information showing execution paths second most to least frequently taken in the section, the execution path specifying step further specifies, based on the number m, second to nth most frequent execution paths where n=m−1, the second code generating step generates n sets of second code corresponding one-to-one to the most to nth most frequent execution paths specified in the execution path specifying step, and the object program generating step generates the object program which causes execution of the first code and the n sets of second code separately, in parallel.

According to this method, the object program is organized for executing two or more frequent execution paths as separate threads.

Here, the object program generating step may generate the object program which further causes stopping of the n sets of second code other than a set of second code for which a condition for taking a corresponding execution path is true.

According to this method, the object program is organized to cause, when a condition for executing one thread is true, other processor elements to stop executing other threads.

Here, the object program generating step may generate the object program which causes retention of any of the stopped sets of second code without deleting.

According to this method, the object program with which a thread can be retained for future use can be generated.

Here, the object program generating step may generate the object program which further causes processor elements respectively executing the first code and the second code to separately treat a same variable, if a memory type of the program conversion and execution device is of a memory sharing type where all processor elements in the program conversion and execution device share one memory.

According to this method, the object program can be generated in accordance with whether the memory type is shared or distributed.

### BRIEF DESCRIPTION OF THE DRAWINGS

These and other objects, advantages and features of the invention will become apparent from the following description thereof taken in conjunction with the accompanying drawings which illustrate a specific embodiment of the invention.

In the drawings:

FIG. 1 is a block diagram showing a construction of a compiler device according to embodiments of the present invention;

FIG. 2 shows a control flow graph for explaining a concept of the present invention;

FIG. 3 shows a representation of the concept of the present invention;

FIG. 4 shows relationships between processor elements and memories;

FIG. 5 shows a source program and its control flow graph used in the embodiments;

FIG. 6 shows code which is a substantially direct translation of the source program shown in FIG. 5 into assembler code;

FIG. 7 shows code corresponding to execution path 500→501→502, in the case where target hardware is of a memory sharing type;

FIG. 8 shows code corresponding to execution path 500→501→503, in the case where the target hardware is of the memory sharing type;

FIG. 9 shows code corresponding to execution path 500→504, in the case where the target hardware is of the memory sharing type;

FIG. 10 shows thread control code in the case where the target hardware is of the memory sharing type;

FIG. 11 shows thread control code in the case where the number of processor elements capable of parallel execution in the target hardware is unknown;

FIG. 12 shows code corresponding to execution path 500→501→502, in the case where the target hardware is of a memory distribution type;

FIG. 13 shows code corresponding to execution path 500→501→503, in the case where the target hardware is of the memory distribution type;

FIG. 14 shows code corresponding to execution path 500→504, in the case where the target hardware is of the memory distribution type;

FIG. 15 is a flowchart showing an operation of detecting an execution frequency;

FIG. 16 is a flowchart showing an operation of making judgments regarding hardware specifications of the target hardware;

FIG. 17 is a flowchart showing a procedure of an executable program in the case where the target hardware is of the memory distribution type;

FIG. 18 is a block diagram showing a program conversion and execution device according to an embodiment of the present invention;

FIG. 19 is a flowchart showing an operation of generating an executable program;

FIG. 20 shows control flow graphs for explaining trace scheduling in the related art; and

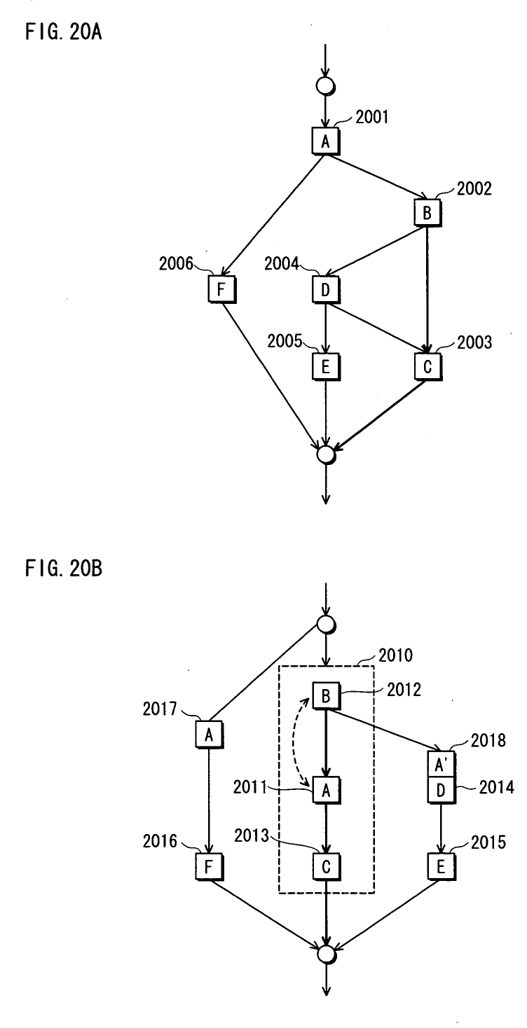

FIG. 21 shows thread control code in the case where the target hardware is of the memory distribution type.

### DESCRIPTION OF THE PREFERRED EMBODIMENTS

The following describes embodiments of a compiler device which is a program conversion device or a program conversion and execution device according to the present invention, with reference to the drawings.

### First Embodiment

A compiler device of a first embodiment of the present invention generates an executable program for a computer of a memory sharing type.

(Overview)

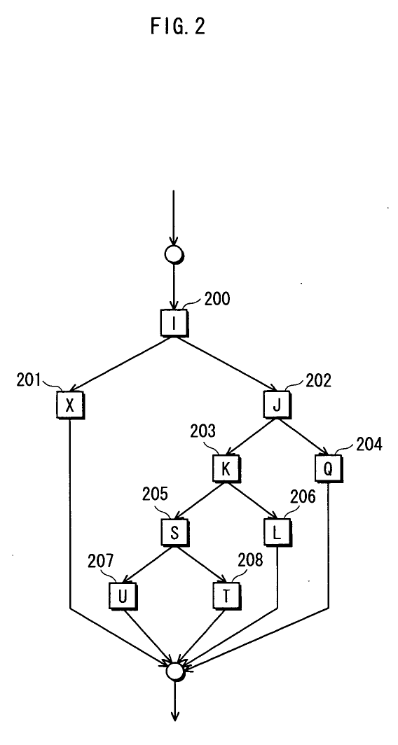

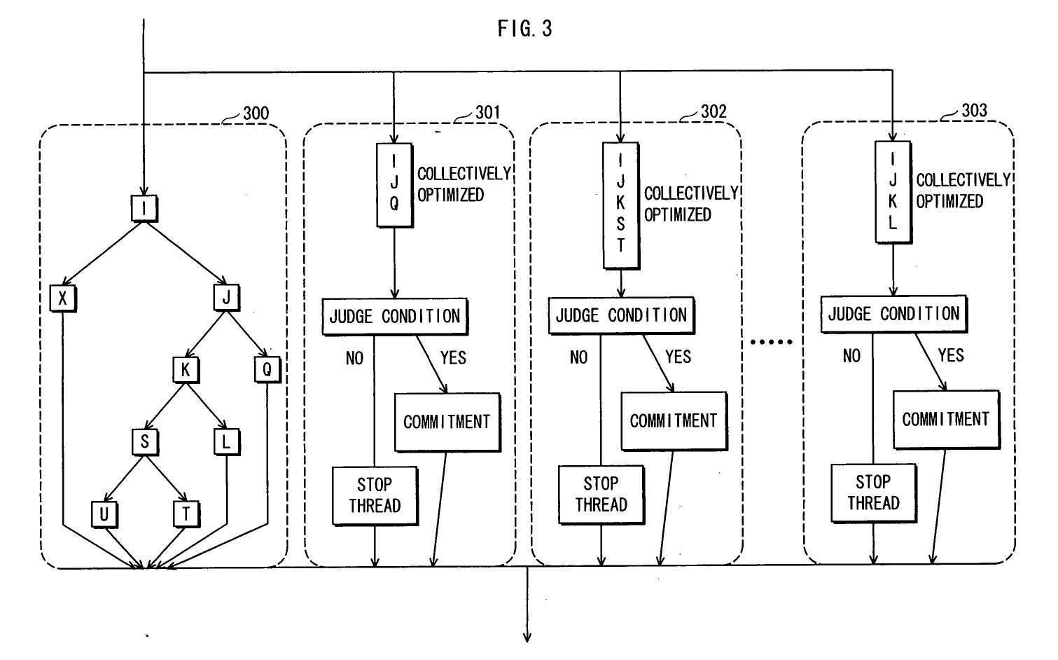

First, an overview of the present invention is given below, by referring to FIGS. 2 and 3.

Suppose the compiler device converts a source program one part of which has branches as shown in a control flow graph of FIG. 2, into an executable program.

In the drawing, blocks I 200, J 202, K 203, L 206, Q 204, S 205, T 208, U 207, and X 201 are each a basic block. As mentioned earlier, a basic block is a sequence of instructions containing no branch in a middle, though it may contain a branch at an end. The executable program generated by the compiler device is designed for use in a computer capable of executing two or more instructions in parallel.

The control flow graph of FIG. 2 includes five execution paths, namely, execution path I 200→J 202→Q 204, execution path I 200 J→202→K 203→S 205→T 208, execution path I 200→X 201, execution path I 200→J 202→K 203→S 205→U 207, and execution path I 200→J 202→K 203→ and L 206. These execution paths have decreasing execution frequencies in this order.

This being so, code corresponding to a sequence of instructions of one or more frequent execution paths out of these execution paths is generated in executable form. Also, code directly corresponding to the original source program is generated in executable form. Then an executable program which causes separate processor elements to execute the code corresponding to the frequent execution paths and the code corresponding to the source program in parallel is generated. FIG. 3 shows a procedure of this executable program in detail. As illustrated, the executable program causes a first processor element to execute thread 300 which is a substantially direct translation of the source program into executable form, a second processor element to execute thread 301 corresponding to the most frequent execution path, a third processor element to execute thread 302 corresponding to the second most frequent execution path, and so on. Thus, the executable program is organized to cause processor elements to launch and execute threads in parallel, so far as the number of processor elements capable of parallel execution and the number of creatable threads permit. The executable program also causes, when a condition for executing one thread is true, a processor element executing that thread to stop the other threads and perform commitment to reflect an operation result of the thread.

This makes it unnecessary to use compensation code. The concurrently-executed threads include thread 300 which is a substantially direct translation of the source program into executable form, the value consistency in the program can be maintained. Also, when control takes one of the execution paths corresponding to threads 301 to 303, an execution result can be obtained faster than when only thread 300 is executed. Hence the overall execution time can be reduced.

(Construction)

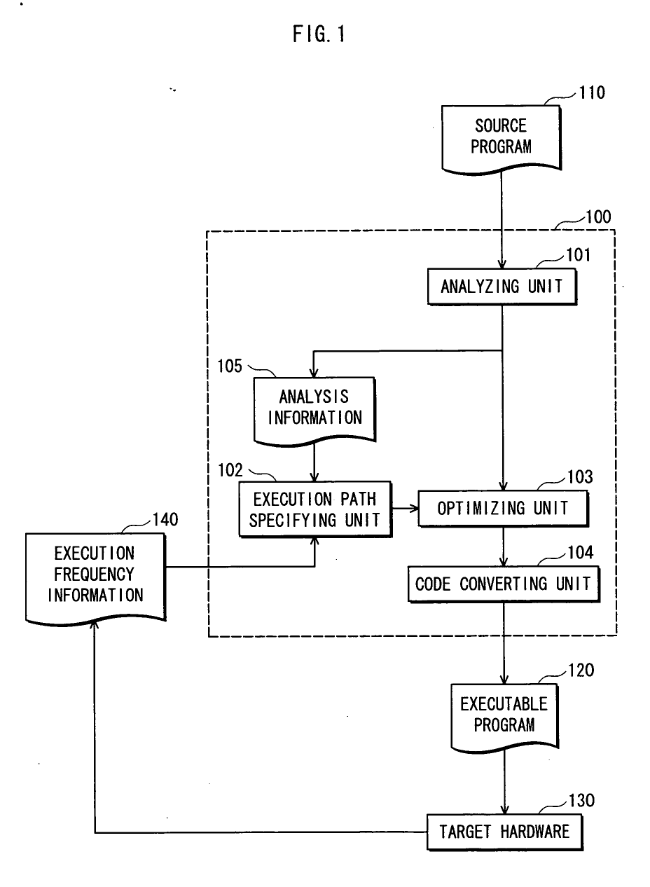

FIG. 1 is a block diagram showing a construction of a compiler device 100 in the first embodiment. As illustrated, the compiler device 100 is roughly made up of an analyzing unit 101, an execution path specifying unit 102, an optimizing unit 103, and a code converting unit 104.

The compiler 100 can actually be realized by a computer system that includes an MPU (Micro Processing Unit), a ROM (Read Only Memory), a RAM (Random Access Memory), and a hard disk device. The compiler device 100 generates an intended executable program in accordance with a computer program stored in the hard disk device or the ROM. Transfers of data between the units are carried out using the RAM.

The analyzing unit 101 analyzes branches and execution contents in a source program 110, and acquires information such as “branch” and “repeat” written in the source program 110. The analyzing unit 101 outputs analysis information 105 obtained as a result of the analysis, to the execution path specifying unit 102.

The execution path specifying unit 102 receives the analysis information 105 which includes identifiers of execution paths in the source program 110, from the analyzing unit 101. The execution path specifying unit 102 also obtains execution frequency information 140 about execution frequencies of the execution paths in the source program 110 converted in executable form. Based on these information, the execution path specifying unit 102 specifies one or more frequent execution paths out of the execution paths, and notifies the optimizing unit 103 of the specified execution paths.

The optimizing unit 103 basically performs optimization for generation of an executable program, such as optimizing an order of instructions in the source program 110. In detail, based on the information received from the analyzing unit 101 and the execution path specifying unit 102, the optimizing unit 103 optimizes an order of instructions of each of the specified execution paths so as not to create any branch to another execution path.

The code converting unit 104 generates an executable program 120 applicable to target hardware 130, in a form where code optimized by the optimizing unit 103 is assigned to a separate processor element in the target hardware 130. The code converting unit 104 outputs the executable program 120 to the target hardware 130.

The executable program 120 is then executed on the target hardware 130. Information about the execution paths, generated as a result of the execution, is sent to the execution path specifying unit 102 as the execution frequency information 140. Here, the execution frequency information 140 indicates which of the execution paths formed by branches has been taken in the execution. If the executable program 120 includes a loop, then the execution frequency information 140 also indicates how many times each individual execution path has been taken in the execution.

The target hardware 130 has a plurality of processor elements, and so is capable of executing two or more instructions in parallel. A memory type of the target hardware 130 is either memory sharing or memory distribution. In the first embodiment, the target hardware 130 is assumed to be of the memory sharing type.

The memory sharing type and the memory distribution type are explained briefly below.

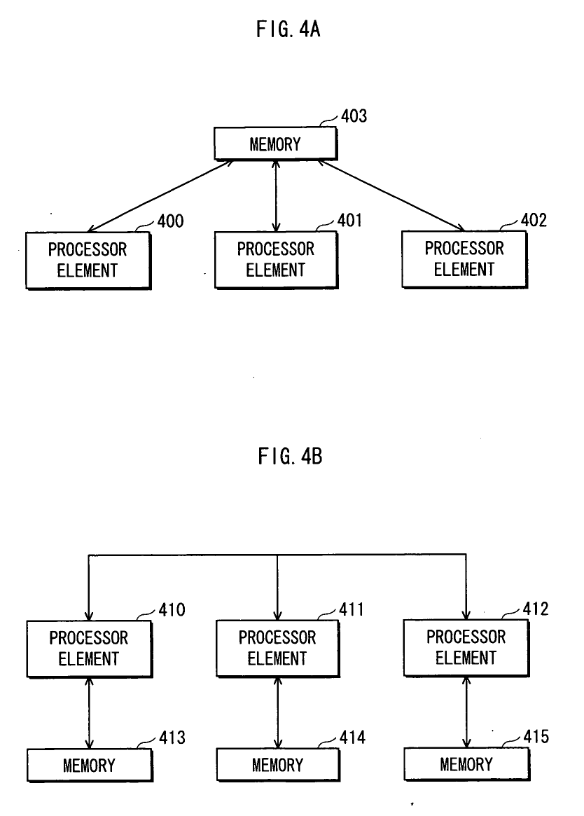

In the memory sharing type, a plurality of processor elements 400 to 402 are connected to a single memory 403, as shown in FIG. 4A. Each of the processor elements 400 to 402 reads necessary data from the memory 403 into its own register, performs an operation using the data in the register, and updates the data stored in the memory 403 based on a result of the operation.

In the memory distribution type, on the other hand, a plurality of processor elements 410 to 412 are connected respectively to memories 413 to 415, as shown in FIG. 4B. A program to be executed by each of the processor elements 410 to 412 is set so as to reflect an operation result of the processor element to all of the memories 413 to 415. For example, when the processor element 410 yields an operation result, not only data stored in the memory 413 but also data stored in the memories 414 and 415 are updated using that operation result.

Though the number of processor elements is three in both of the above examples, the number of processor elements is not limited to this.

(Data)

Data input in the compiler device 100 includes the source program 110, the execution frequency information 140, and information about hardware specifications of the target hardware 130. The following gives an explanation on these data.

The execution frequency information 140 is made up of the identifiers of the execution paths, which are assigned by the analyzing unit 101, and information showing how many times the execution paths identified by the identifiers have each been used in actual execution on the target hardware 130 or other hardware capable of executing an executable program. An execution path which has been taken a largest number of times is set as an execution path having a highest execution frequency, an execution path which has been taken a second largest number of times is set as an execution path having a second highest execution frequency, and soon. The execution frequency information 140 is stored on a RAM of the target hardware 130, and sent to the compiler device 100 and stored in the RAM therein.

The information about the hardware specifications of the target hardware 130 includes memory information and parallel execution information. The memory information indicates the memory type of the target hardware 130. The memory information is set to 0 if the target hardware 130 is of the memory sharing type, and 1 if the target hardware 130 is of the memory distribution type. The memory information is sent from the target hardware 130 to the compiler device 100 and stored in the RAM of the compiler device 100. The parallel execution information indicates the number of instructions that can be executed in parallel by the target hardware 130, that is, the number of processor elements in the target hardware 130. The parallel execution information is sent from the target hardware 130 to the compiler device 100 and stored in the RAM of the compiler device 100, too.

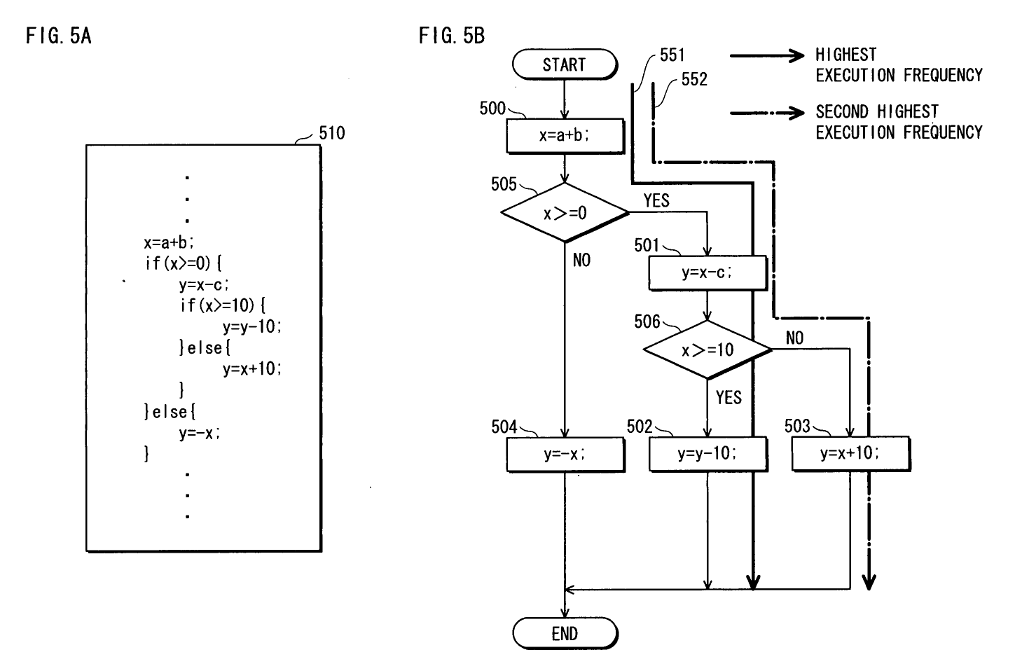

The source program 110 is, as one example, written as shown in FIG. 5A.

In the first embodiment, a source program section 510 shown in FIG. 5A is converted by the compiler device 100 as one example of the source program 110. The following explains the contents of the source program section 510 and code generated from the source program section 510 by the compiler device 100.

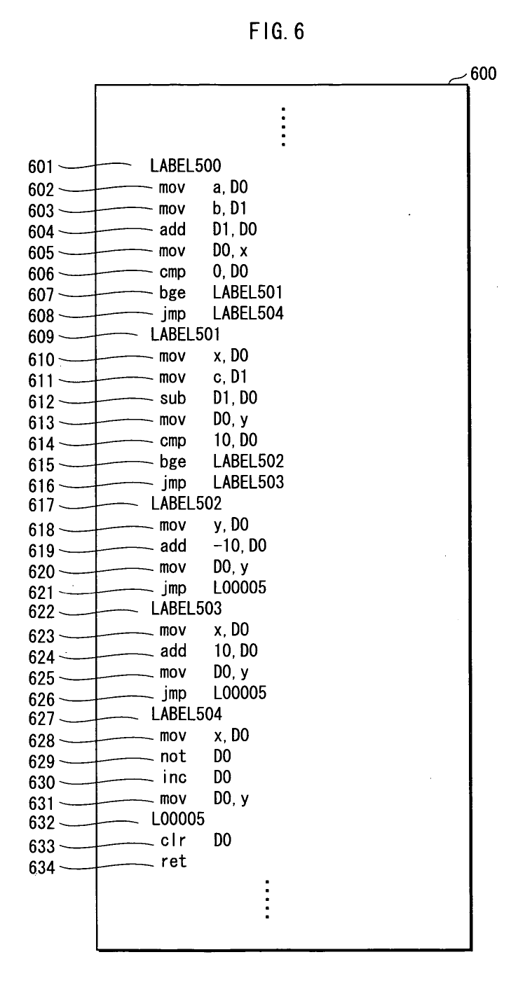

The contents of the source program section 510 shown in FIG. 5A are explained first. Note that code shown in FIGS. 6 to 10 is generated by the compiler device 100 in order to execute at least part of the contents of this source program section 510.

The source program section 510 is one part of the source program 110 that is repeated many times in the source program 110. FIG. 5B shows a control flow graph of the source program section 510. The contents of the source-program section 510 are explained by referring to this control flow graph.

First, instruction block 500 adds a and b and stores a resulting sum in x. Branch block 505 judges whether x≧0. If x<0 (505: NO), control proceeds to instruction block 504, which stores minus x in y. If x≧0 (505: YES), control proceeds to instruction block 501, which subtracts c from x and stores a resulting difference in Y.

After this, branch block 506 judges whether x≧10. If x≧10 (506: YES), control proceeds to instruction block 502, which subtracts 10 from y and stores a resulting difference in y. If x<10 (506: NO), control proceeds to instruction block 503, which adds x and 10 and stores a resulting sum in y.

Here, the values a, b, and c have already been given in a preceding section of this source program section 510. Suppose, of three execution paths created by the conditional branches in the source program section 510, execution path 551 has a highest execution frequency and execution path 552 has a second highest execution frequency. Information about such execution frequencies can be obtained by executing, on the target hardware 130, an executable program which is a substantially direct translation of the source program 110 without optimization.

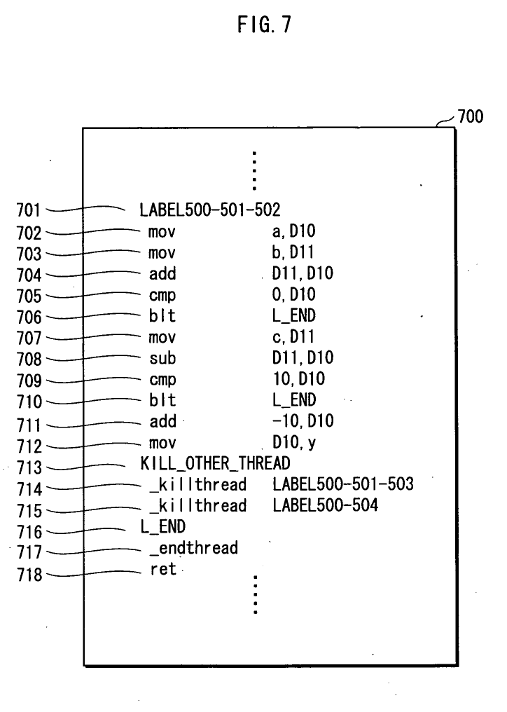

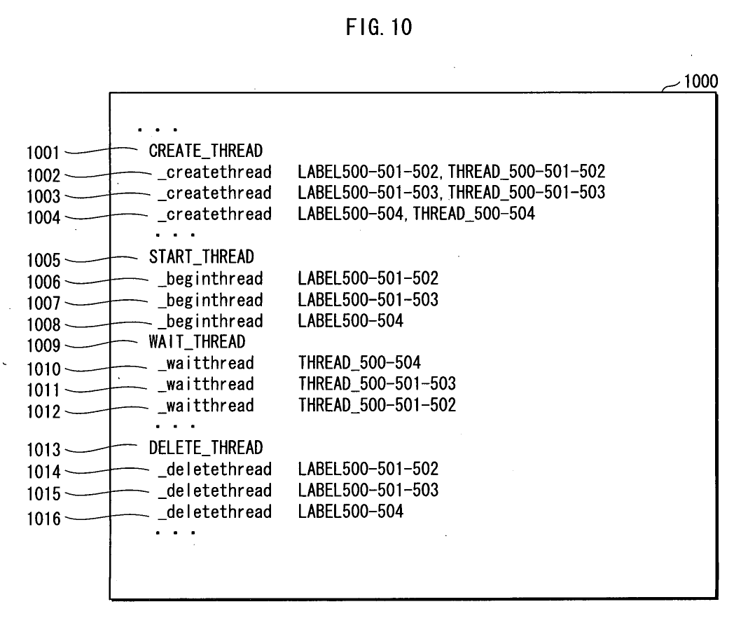

The code shown in FIGS. 6 to 10 is assembler code representing a program output from the compiler device 100, and is generated based on the source program section 510 shown in FIG. 5A. Thread 1000 shown in FIG. 10 is a main thread. Threads 700, 800, and 900 shown respectively in FIGS. 7, 8, and 9 are used in the main thread. Though not shown in the code, these threads are structured to be executed by separate processor elements in the target hardware 130.

Thread 600 shown in FIG. 6 is assembler code representing the source program section 510 without optimization. Though not shown in FIG. 10, thread 600 is contained in thread 1000 which is the main thread.

It is assumed here that lines of code in each thread are executed in sequence from a first line. A meaning of an instruction corresponding to each line of code will be described later.

In thread 600, code 601, 609, 617, 622, 627, and 632 is label code which is used to indicate a branch target in a program.

Code 602 to 608 corresponds to blocks 500 and 505 in FIG. 5B.

Code 610 to 616 corresponds to blocks 501 and 506 in FIG. 5B.

Code 618 to 621 corresponds to block 502 in FIG. 5B.

Code 623 to 626 corresponds to block 503 in FIG. 5B.

Code 628 to 631 corresponds to block 504 in FIG. 5B.

Code 633 and 634 corresponds to an ending operation of thread 600.

On the other hand, threads 700, 800, and 900 shown respectively in FIGS. 7 to 9 each correspond to a sequence of instructions in a frequent execution path.

FIG. 7 shows thread 700 generated by optimizing the sequence of instructions in execution path 551 having the highest execution frequency.

In thread 700, code 701, 713, and 716 is label code.

Code 702 to 712 corresponds to blocks 500, 501, and 502 without any branch to another execution path, and includes, as code corresponding to blocks 505 and 506, code that indicates a binary decision of whether or not control takes execution path 551.

Code 714 and 715 stops other threads 800 and 900 when control takes execution path 511.

Code 717 and 718 corresponds to an ending operation of thread 700.

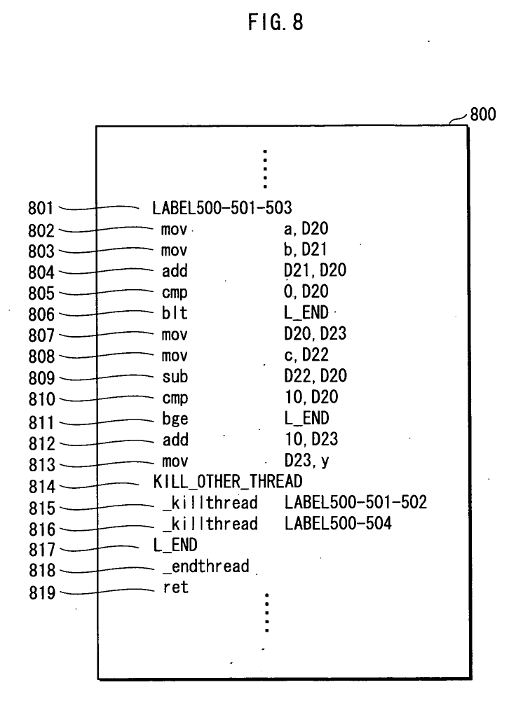

FIG. 8 shows thread 800 generated by optimizing the sequence of instructions in execution path 552 having the second highest execution frequency.

In thread 800, code 801, 814, and 817 is label code.

Code 802 to 813 corresponds to blocks 500, 501, and 503 without any branch to another execution path.

Code 815 and 816 stops other threads 700 and 900 when control takes execution path 552.

Code 818 and 819 corresponds to an ending operation of the thread 800.

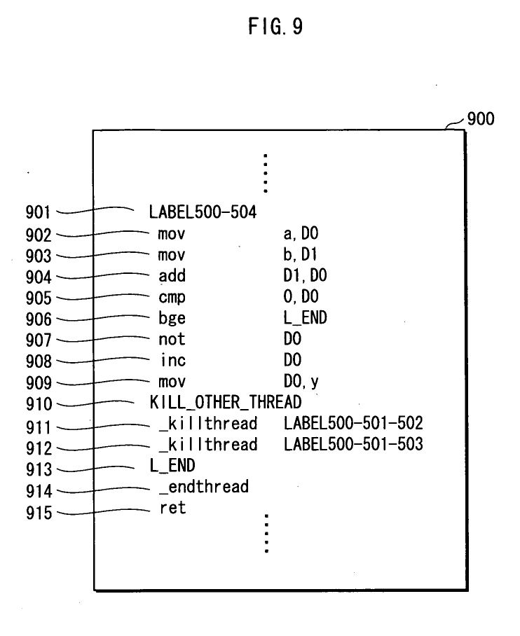

FIG. 9 shows thread 900 generated by optimizing the sequence of instructions in the execution path connecting blocks 500 and 504.

In thread 900, code 901, 910, and 913 is label code.

Code 902 to 909 corresponds to blocks 500 and 504 without any branch to another execution path.

Code 911 and 912 stops other threads 700 and 800 when control takes this execution path.

Code 914 and 915 corresponds to an ending operation of thread 900.

The lines of code 702, 802, and 902 shown respectively in FIGS. 7, 8, and 9 are substantially same code which stores a in a register, but designate different registers. This is because the target hardware 130 is of the memory sharing type and therefore if a is stored in a same register, the value consistency in each thread cannot be guaranteed, with it being impossible to produce an execution result desired by a programmer.

FIG. 10 shows thread 1000 composed of thread control code for causing the target hardware 130 to execute threads 600, 700, 800, and 900 shown respectively in FIGS. 6 to 9 in parallel. Thread 1000 is the main thread in the case where the target hardware 130 is of the memory sharing type.

In thread 1000, code 1001 to 1004 sets the threads corresponding to the frequent execution paths specified based on the analysis information 104 and the execution frequency information 140. In this example, the threads corresponding to all execution paths of the source program section 510 are set on the assumption that the target hardware 130 has a sufficient number of processor elements.

Code 1006 to 1008 designated by label code 1005 causes the processor elements to start the corresponding threads.

Code 1010 to 1012 designated by label code 1009 waits for the corresponding threads to end.

Code 1014 to 1016 designated by label code 1013 abandons the corresponding threads and releases the processor elements after all threads have ended.

The compiler device 100 generates the executable program 120 that includes main thread 1000 and threads 600, 700, 800, and 900. Note here that threads 600, 700, 800, and 900 are to be executed in parallel.

The following gives an explanation of code shown in FIGS. 6 to 14 and 21.

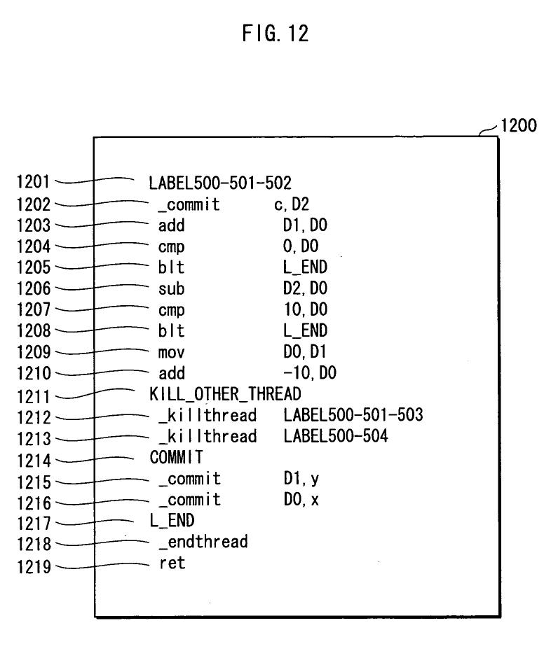

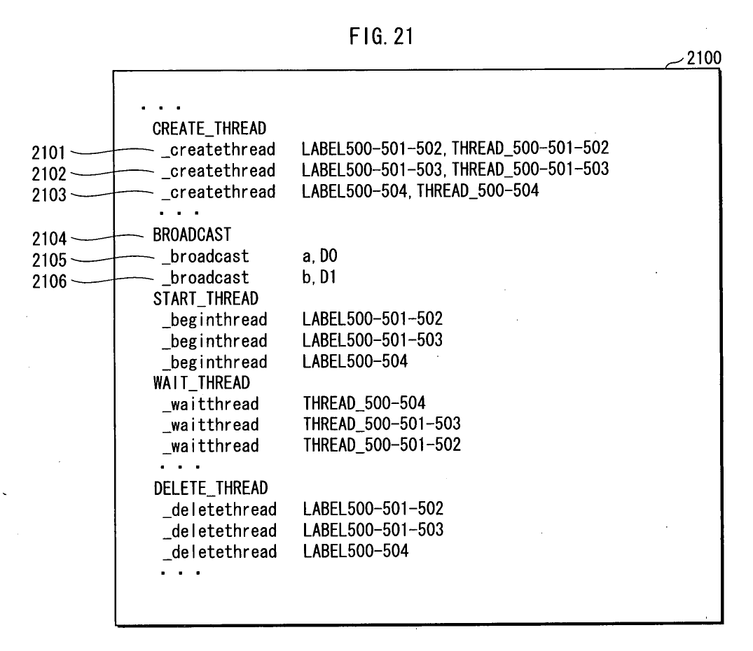

As mentioned earlier, FIG. 6 shows the code which is a substantially direct translation of the source program section 510 without optimization. FIGS. 7, 8, and 9 respectively show the code generated by performing optimization with regard to execution path 551, execution path 552, and the execution path connecting blocks 501 and 504, and FIG. 10 shows the thread control code, in the case where the target hardware 130 is of the memory sharing type. On the other hand, FIGS. 12, 13, and 14 respectively show code generated by performing optimization with regard to execution path 551, execution path 552, and the execution path connecting blocks 501 and 504, and FIG. 21 shows thread control code, in the case where the target hardware 130 is of the memory distribution type.

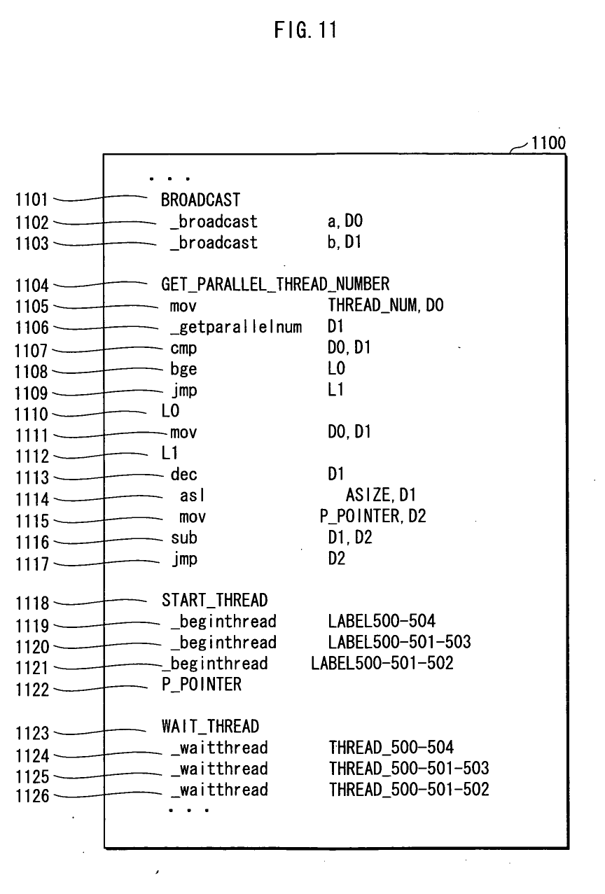

Also, FIG. 10 shows the thread control code in the case where the number of instructions executable in parallel by the target hardware 130 is known, whereas FIG. 11 shows thread control code in the case where the number of instructions executable in parallel by the target hardware 130 is unknown.

In the following explanation, each address represents an address of an instruction on a processor, such as an address of a register or a value stored in a register.

Code “mov (address 1), (address 2)” stores a value at address 1 in a register at address 2. For example, code 602 in FIG. 6 stores a value at address a in register D0.

Code “add (address 1), (address 2)” adds a value at address 1 and a value at address 2 and updates the value at address 2 using a resulting sum. For example, code 604 in FIG. 6 adds a value in register D1 and a value in register D0 and stores a resulting sum in register D0.

Code “sub (address 1), (address 2)” subtracts a value at address 1 from a value at address 2 and updates the value at address 2 using a resulting difference. For example, code 612 in FIG. 6 subtracts a value in register D1 from a value in register D0 and stores a resulting difference in register D0.

Code “cmp (address 1), (address 2)” compares a value at address 1 with a value at address 2. For example, code 606 in FIG. 6 compares 0 with a value in register D0.

Code “bge (address 3)” jumps to code at address 3 if a value at address 2 is no less than a value at address 1 in immediately preceding code “cmp (address 1), (address 2)”. Otherwise, control proceeds to immediately succeeding code. For example, code 607 in FIG. 6 causes a jump to code 609 without proceeding to code 608, if a value in register D0 is no less than 0 in immediately preceding code 606.

Code “blt (address 3)” jumps to code at address 3 if a value at address 2 is less than a value at address 1 in immediately preceding code “cmp (address 1), (address 2)”. Otherwise, control proceeds to immediately succeeding code. For example, code 706 in FIG. 7 causes a jump to code 716 while skipping code 707 to 715, if a value in register D10 is less than 0 in immediately preceding code 705.

Code “jmp (address 1)” jumps to code at address 1. For example, code 608 in FIG. 6 causes a jump to code 627 while skipping code 609 to 626.

Code “not (address 1)” inverts each bit of a value at address 1, i.e. the ones complement form of the value at address 1, and updates the value at address 1 using a resulting value. For example, code 629 in FIG. 6 inverts each bit of a value in register D0 (the ones complement form) and stores a resulting value in register D0.

Code “inc (address 1)” adds 1 to a value at address 1, and updates the value at address 1 using a resulting sum. For example, code 630 in FIG. 6 adds 1 to a value in register D0 and stores a resulting sum in register D0.

Code “dec (address 1)” subtracts 1 from a value at address 1, and updates the value at address 1 using a resulting difference. For example, code 1113 in FIG. 11 subtracts 1 from a value in register D1, and stores a resulting difference in register D1.

Code “clr (address 1)” clears a value at address 1 by setting the value at 0. For example, code 633 in FIG. 6 clears a value in register D0 to initialize register D0.

Code “as1 (address 1), (address 2)” is used to prevent a discrepancy in address caused by a difference in instruction word length used by the target hardware 130. This code is mainly needed when transiting from one code to another. An address of each instruction in a program is managed in an instruction word length unit. Suppose the instruction word length is 8 bits. If an address of instruction 1 is 0, then an address of instruction 2 which follows instruction 1 is 8. When transitioning from instruction 1 to instruction 2, simply adding 1 to the address of instruction 1 does not yield the address of instruction 2, and therefore instruction 2 cannot be executed due to an inconsistency in address. In view of this, code “as1 (address 1), (address 2)” multiplies a value at address 2 by a value at address 1 which represents the instruction word length, and stores a resulting product in a register at address 2.

Code “ret” causes a return to the main thread.

Thread control code is explained next.

Code “_createthread (address 1), (address 2)” creates a thread beginning with address 1, and stores information about execution of the thread in a register at address 2. For example, code 1002 in FIG. 10 creates a thread beginning with LABEL500-501-502, i.e. thread 700 shown in FIG. 7, and stores information about execution of the thread in THREAD500-501-502.

Code “_beginthread (address)” starts a thread at the address. For example, code 1006 in FIG. 10 starts a thread beginning with LABEL500-501-502, i.e. thread 700 shown in FIG. 7.

Code “_endthread” sets a thread in an end state and returns information indicating the end of the thread. For example, code 717 in FIG. 7 ends thread 700 and returns information indicating the end of thread 700 to the main thread.

Code “_deletethread (address)” abandons a thread beginning with the address. For example, code 1014 in FIG. 10 abandons a thread beginning with LABEL500-501-502, i.e. thread 700 shown in FIG. 7.

Code “_killthread (address)” terminates execution of a thread beginning with the address. For example, code 714 in FIG. 7 stops a thread beginning with LABEL500-501-502, i.e. the thread 800 shown in FIG. 8, even if thread-800 is still in execution.

Code “_waitthread (address)” waits for completion of a thread beginning with the address. The completion can be notified by the information from the aforementioned _endthread“. For example, code 1010 in FIG. 10 waits for completion of THREAD500-504, i.e. thread 900 shown in FIG. 9.

Code “_commit (address 1), (address 2)” reflects information at address 1, which is generated in any of the main thread and the other threads, onto a register at address 2 of all of the main thread and the other threads.

Code“_broadcast (address 1), (address 2)” reflects an execution result of one processor element onto all memories connected with the processor elements in the target hardware 130 in the case where the target hardware 130 is of the memory distribution type. This code updates a value at address 2 of all memories using a value at address 1 of a memory corresponding to the processor element.

Code “_getparallelnum (address)” returns the number of threads executable in parallel by the target hardware 130 to the address. This code is used to detect the number of processor elements capable of parallel execution in the target hardware 130. In particular, this code is necessary when the number of processor elements capable of parallel execution in the target hardware 130 is unknown at the time of compilation.

(Operations)

Operations of the compiler device 100 in generating the executable program 120 are described below, using flowcharts.

Upon input of the source program 110 in the compiler device 100, the analyzing unit 101 obtains information about the branches and repeats in the source program 110, detects the execution paths based on the obtained information, and assigns the identifiers to the execution paths.

Initially, the source program 110 is converted to an executable program without optimization, via the optimizing unit 103 and the code converting unit 104. This executable program is executed on the target hardware 130, to obtain information about the execution frequencies of the execution paths.

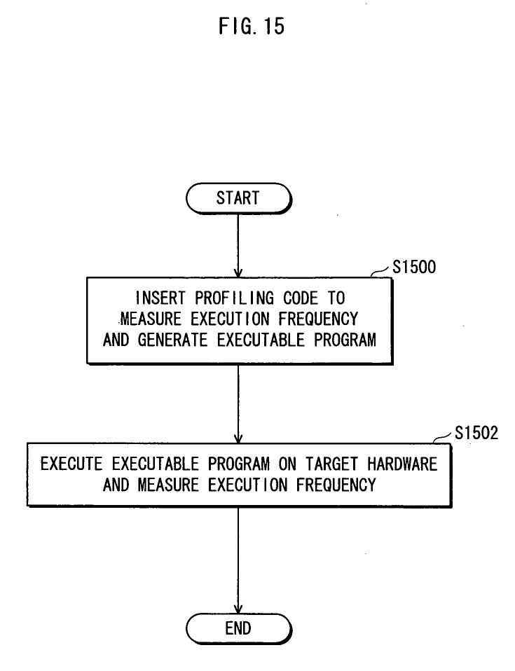

FIG. 15 is a flowchart showing an operation of obtaining the information about the execution frequencies of the execution paths.

To measure the execution frequencies of the execution paths in the source program section 510, the optimizing unit 103 converts the source program section 510 without optimization and inserts profiling code to thereby generate executable code. The code converting unit 104 converts the executable code to an executable program that can run on the target hardware 130 (S1500). The profiling code referred to here is used to detect which execution path is taken at a conditional branch. The profiling code increments a count, which corresponds to an identifier of an execution path, by 1 whenever control takes that execution path. When the profiling code is inserted, the execution speed of the executable program decreases. Accordingly, the profiling code will not be inserted in the intended executable program eventually produced from the compiler device 100.

The executable program which is a substantially direct translation of the source program section 510 with the profiling code is then executed on the target hardware 130, to count the execution frequencies of the execution paths (S1502). Each time an execution path is taken, a count corresponding to an identifier of that execution path is incremented by 1. Information showing the execution frequencies of the execution paths counted in this way is stored on the RAM of the target hardware 130 as the execution frequency information 140. The execution frequency information 140 is then output to the execution path specifying unit 102 in the compiler device 100. Based on this information, the intended executable program is generated.

When outputting the execution frequency information 140 to the compiler device 100, the target hardware 130 also outputs the information about its hardware specifications. This information includes the memory information showing the memory type of the target hardware 130 and the parallel execution information showing the number of processor elements capable of parallel execution in the target hardware 130. These information is stored on a ROM of the target hardware 130 beforehand, and output to the compiler device 100 along with the execution frequency information 140.

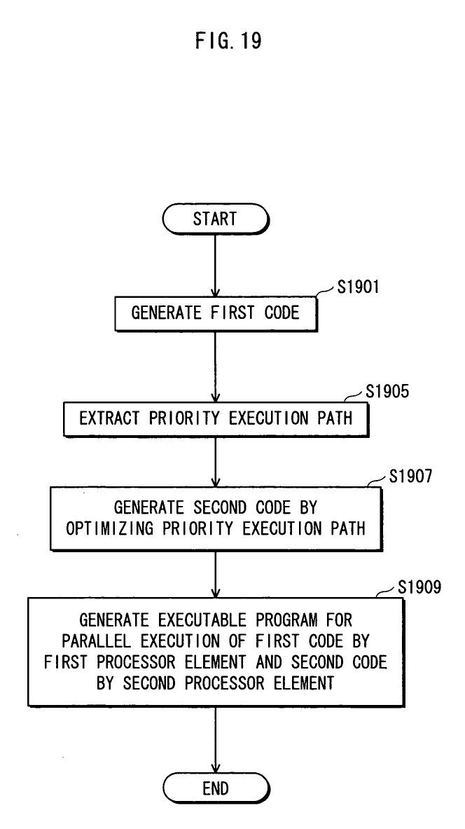

FIG. 19 is a flowchart showing an operation of generating the intended executable program by the compiler device 100.

First, the optimizing unit 103 generates first code which is a substantially direct translation of the source program 110 into executable form (S1901). The execution path specifying unit 102 extracts one or more priority execution paths, i.e. one or more frequent execution paths, in descending order of execution frequency, based on the execution frequency information 140 obtained from the target hardware 130 (S1905). The optimizing unit 103 generates second code by optimizing the sequence of instructions in each of the priority execution paths, based on the number of processor elements capable of parallel execution in the target hardware 130 (S1907). Here, sets of second code which each correspond to a different one of the priority execution paths can be generated up to the number which is 1 smaller than the number of processor elements capable of parallel execution. In detail, for each of the priority execution paths in descending order of execution frequency, a thread corresponding to optimized instructions in that execution path is generated. As one example, if the number of processor elements capable of parallel execution is four, threads corresponding to execution paths having first to third highest execution frequencies are generated. Note here that the first code and code for controlling the generated sets of second code are included in a same thread.

After this, the code converting unit 104 generates an executable program applicable to the target hardware 130, from the code organized to execute the first code and the sets of second code in parallel (S1909).

This operation is explained in detail below, using a specific example of converting the source program section 510 shown in FIG. 5A to an executable program.

Upon input of the source program 110 including the source program section 510 shown in FIG. 5A in the compiler device 100, the analyzing unit 101 analyzes the source program section 510, and detects the three execution paths, namely, execution path 500→501→502 (execution path 551), execution path 500→501→503 (execution path 552), and execution path 500→504 shown in FIG. 5B. The analyzing unit 101 assigns an identifier to each of these execution paths. The optimizing unit 103 generates code for thread 600 which is a substantially direct translation of the source program section 551 into assembler code without optimization. The optimizing unit 103 inserts profiling code in the generated code. The code converting unit 104 converts the code to an executable program applicable to the target hardware 130.

The executable program is executed by the target hardware 130. Based on this execution, the target hardware 130 generates the execution frequency information 140 showing the execution frequencies of the execution paths, and outputs it to the compiler device 100. For example, the execution frequency information 140 shows that execution path 500→501→502 has been executed twenty-four times, execution path 500→501→503 has been executed fifteen times, and execution path 500→504 has been executed three times. The target hardware 130 also outputs the information about its hardware specifications to the compiler device 100. For example, this information includes the memory information which is set at 0 indicating the memory sharing type, and the parallel execution information showing that the number of processor elements capable of parallel execution is four.

The execution path specifying unit 102 receives the execution frequency information 140. Based on the execution frequency information 140, the optimizing unit 103 generates main thread 1000. Since the number of processor elements capable of parallel execution is four, the number of concurrently executable threads is four including thread 600 which is contained in main thread 1000. Accordingly, three threads 700, 800, and 900 are generated in main thread 1000. The optimizing unit 103 generates code for causing each of threads 600, 700, 800, and 900 to be executed by a separate processor element. The code converting unit 104 generates the executable program 120 applicable to the target hardware 130, from the code generated by the optimizing unit 103.

The above explanation uses the example of the source program section 510, which can of course be followed by another source program section. If an execution condition of any of threads 700, 800, and 900 is true, executable code corresponding to the succeeding source program section is executed after that thread. If an execution condition of each of threads 700, 800, and 900 is false, the executable code corresponding to the succeeding source program section is executed after thread 600.

### Second Embodiment

A second embodiment of the present invention describes the case where the target hardware 130 is of the memory distribution type. The following explanation mainly focuses on the differences from the first embodiment.

The second embodiment differs from the first embodiment mainly in that, since each processor element is connected to a separate memory and uses a value in that memory, there is no danger of a performance drop caused by memory access contention, unlike in the case of the memory sharing type.

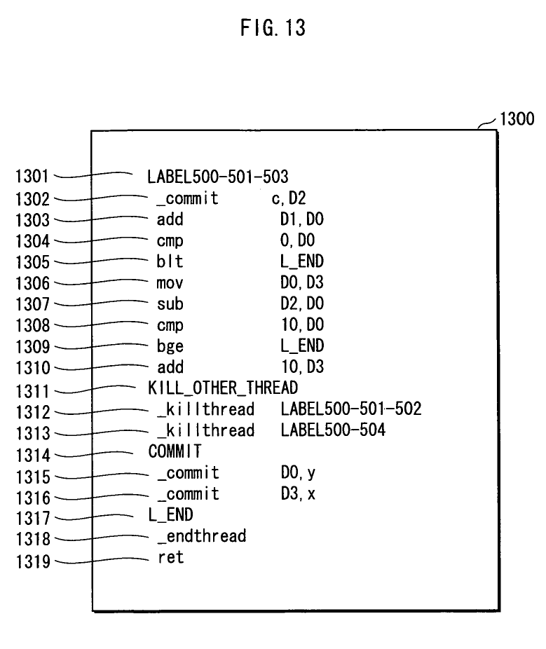

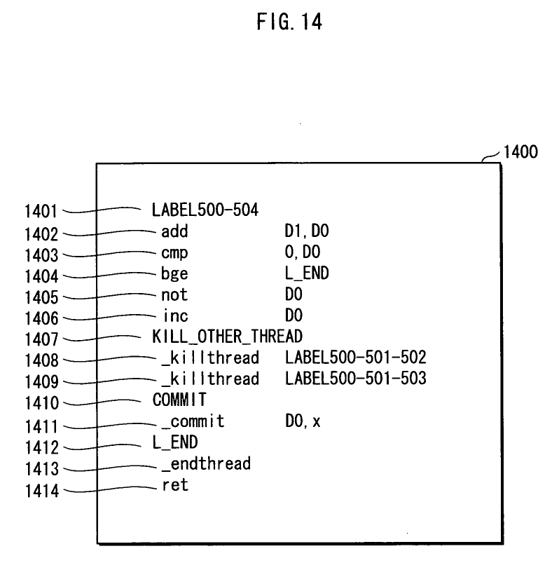

This is explained in detail using the code shown in FIGS. 12 to 14 and 21. FIG. 12 shows thread 1200 which has the same execution contents as thread 700 shown in FIG. 7. FIG. 13 shows thread 1300 which has the same execution contents as thread 800 shown in FIG. 8. FIG. 14 shows thread 1400 which has the same execution contents as thread 900 shown in FIG. 9. FIG. 21 shows main thread 2100 in the case of the memory distribution type.

When the target hardware 130 is of the memory sharing type, the value a needs to be stored in a register in each of threads 700, 800, and 900, as indicated by code 702, 802, and 902 in FIGS. 7 to 9. In the case of the memory distribution type, such storage is unnecessary, since main thread 2100 broadcasts the value a to registers of the memories corresponding to threads 1200, 1300, and 1400 as indicated by code 2104 to 2106 shown in FIG. 21.

In more detail, code 2105 causes the processor elements corresponding to threads 1200, 1300, and 1400 generated by code 2101 to 2103, to store the value a in register D0 of the respective memories.

Likewise, code 2106 causes the processor elements corresponding to threads 1200, 1300, and 1400 generated by code 2101 to 2103, to store the value b in register D1 of the respective memories.

If an execution condition of any of threads 1200, 1300, and 1400 is true, an execution result of that thread needs to be reflected onto the memory connected to the processor element that runs main thread 2100. This can be realized by “_commit” code. For example, code 1215 and 1216 shown in FIG. 12 is such code. This code enables an execution result of a thread to be reflected onto the memory of the main thread.

In the case where the target hardware 130 is of the memory distribution type, an executable program organized to include threads 1200, 1300, and 1400 and main thread 2100 which contains thread 600 is generated by the compiler device 100. Such an executable program can be properly executed on the target hardware 130 while maintaining the value consistency.

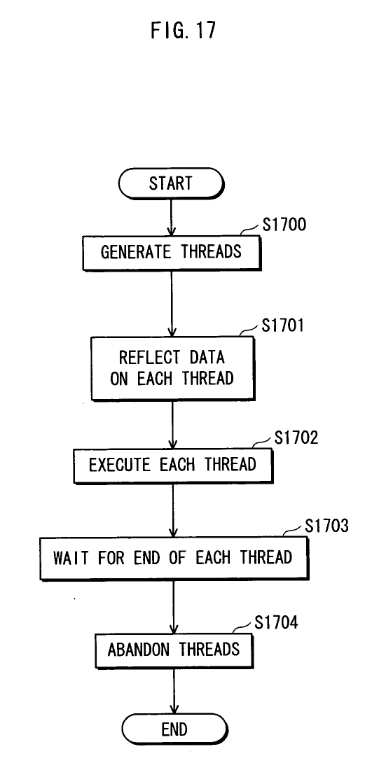

A procedure of the executable program in the case of the memory distribution type is described below, with reference to a flowchart of FIG. 17. The following explanation mainly focuses on a procedure of main thread 2100.

First, the threads to be executed by the other processor elements, namely, threads 1200, 1300, and 1400, are generated (S1700). Data obtained in a preceding source program section is broadcast to and stored in a memory of each of these processor elements (S1701). Following this, each thread is executed (S1702). Once all threads have ended (S1703), the threads are abandoned (S1704).

### Third Embodiment

The first and second embodiments describe the case where the number of instructions that can be execute in parallel by the target hardware 130 is known to the compiler device 100. However, there may be a case where the number of processor elements capable of parallel execution in the target hardware 130 is unknown. Such a case includes when the execution frequency information 140 and the memory information are provided to the compiler device 100 beforehand, and the compiler device 100 needs to generate the executable program 120 without transfer of information from the target hardware 130 to the compiler device 100. In such a case, code for obtaining the number of processor elements and code for setting the number of threads according to the number of processor elements need to be contained in the main thread. FIG. 11 shows code of main thread 1100 in the case where the number of processor elements is unknown. The following explains the execution contents of this code. Suppose here that the compiler device 100 generates four threads 600, 700, 800, and 900 shown in FIGS. 6 to 9.

Code 1105 to 1117 designated by label code 1104 obtains the number of processor elements of the target hardware 130 and sets the number of threads according to the number of processor elements.

First, the number of threads generated by the compiler device 100, denoted by m, is obtained and stored in register D0 (code 1105). Next, the number of processor elements capable of parallel execution in the target hardware 130, denoted by n, is obtained and stored in register D1 (code 1106). The number m in register D0 is compared with the number n in register D1 (code 1107). If n≧m, control jumps to label code 1110 (code 1108) If n<m, control jumps to label code 1112 (code 1109).

If n≧m, no adjustment is necessary, so that m is stored in register D1 (code 1111).

If n<m, the number of threads exceeds the number of concurrently executable instructions, which means it is impossible to execute all threads.

Accordingly, a number obtained by subtracting 1 from n in register D1 is stored in register D1 (code 1113). This number n−1 represents the number of executable threads. One extra processor element is used to execute thread 600 which is a substantially direct translation of the source program 110.

Next, to calculate an instruction address, n−1 is multiplied by the instruction word length (code 1114). For instance, if the instruction word length is 8 bits, then n−1 is multiplied by 8. After this, P_POINTER is stored in register D2 (code 1115). The value in register D1 is subtracted from the value in register D2, and register D2 is updated using a resulting difference (code 1116). After this, control jumps to the address in register D2 (code 1117). Thus, the value in register D2 determines which of threads 700, 800, and 900 is to be started. For instance, if the number of processor elements capable of parallel execution is two, control jumps to code 1121. If the number of processor elements capable of parallel execution is three, control jumps to code 1120. Note here that code 1119 to 1121 respectively starts threads 900, 800, and 700 which correspond to the execution paths in ascending order of execution frequency.

By using such main thread 1100, the compiler device 100 can generate the intended executable program 120 even when the number of processor elements capable of parallel execution in the target hardware 130 is unknown. Though omitted in FIG. 11, code following code 1126 is the same as code following code 1012 in FIG. 10.

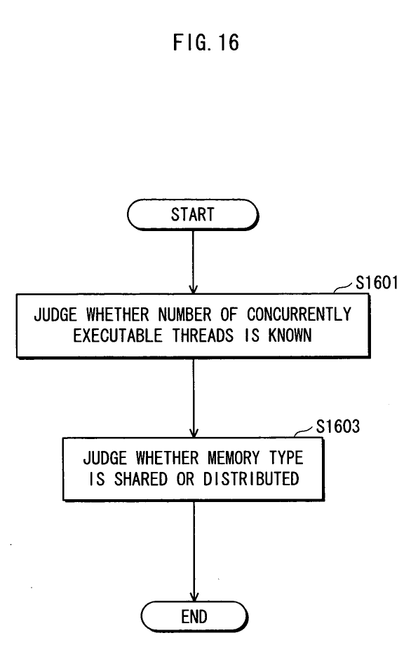

FIG. 16 is a flowchart showing an operation of making judgments on the hardware specifications of the target hardware 130.

First, the optimizing unit 103 judges whether the number of concurrently executable threads by the target hardware 130 is known or unknown (S1601). This judgment can be made according to whether the compiler device 100 has obtained the parallel execution information from the target hardware 130. If the number of concurrently executable threads is unknown, the code shown in FIG. 11 is generated. The optimizing unit 103 also obtains the memory information, and judges whether the target hardware 130 is of the memory sharing type or the memory distribution type (S1603). Based on this judgment, the executable program 120 is generated.

### Fourth Embodiment

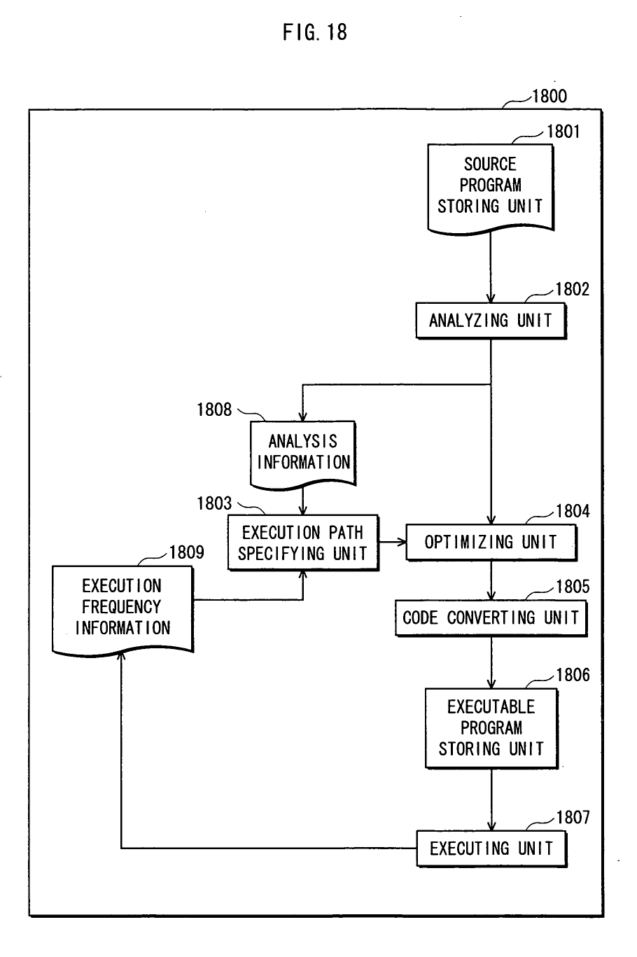

A fourth embodiment of the present invention differs from the first to third embodiments in that a unit for executing a program is included in the compiler device. FIG. 18 is a block diagram showing a program conversion and execution device 1800 in which a unit for executing a program has been included.

In more detail, the program conversion and execution device 1800 includes a source program storing unit 1801, an executable program storing unit 1806, and an executing unit 1807, in addition to the construction elements of the compiler device 100. This saves a trouble of connecting to the target hardware, in order to have the target hardware execute an initial executable program to obtain the execution frequency information. The program conversion and execution device 1800 can obtain an execution result of the executable program and the execution frequency information on its own.

The source program storing unit 1801 stores an input source program.

The executable program storing unit 1806 is used to store an executable program generated by a code converting unit 1805. The executable program storing unit 1806 includes a RAM.

The executing unit 1807 reads the executable program from the executable program storing unit 1806, and executes the read executable program. The executing unit 1807 includes an MPU, a ROM, and a RAM, and functions in the-same way as the target hardware 130 shown in FIG. 1. The MPU of the executing unit 1807 is constituted by a plurality of processor elements.

Code generated in the program conversion and execution device 1800 is the same as that in the first to third embodiments.

According to this construction, the program conversion and execution device 1800 can be used as an interpreter that executes a program while converting it.

Modifications

Although the present invention has been described by way of the above embodiments, the present invention should not be limited to the above. Example modifications are given below.

(1) The first and second embodiments describe the case where the target hardware has a sufficient number of processor elements for executing all of the generated threads. If there are only a few processor elements such as two, however, the main thread is organized so that, for example, only threads 600 and 700 are executed in parallel. In such a case, code 1003, 1004, 1007, 1008, 1011, 1012, 1015, and 1016 shown in FIG. 10 is omitted.

(2) The above embodiments describe the case where the intended executable program is generated on the assumption that the first code, that is, thread 300 shown in FIG. 3, is slower than the other threads.

Alternatively, code for stopping the other threads may be inserted at the end of thread 300 in consideration of a case where thread 300 is faster than the other threads.

(3) The above embodiments describe the case where the target hardware has a plurality of processor elements. As an alternative, regarding one personal computer as one processor element, a plurality of personal computers may be connected to the compiler device via a network so as to perform parallel execution.

(4) The above embodiments describe the case where when an execution condition of one thread is true, a processor element executing another thread stops the execution, deletes the thread and operation data, and then executes a newly assigned thread. However, when the same thread is repeated over and over again, it is inefficient to reassign the same thread each time, as this could decrease the execution speed of the object program. Accordingly, if the next thread is the same as the current thread and only differs in operation data, the object program which includes code for retaining the current thread without abandoning it and broadcasting only necessary operation data may be generated.

(5) The above embodiments describe the case where the object program is generated by the functional units of the device operating in conjunction with each other. However, the present invention may also be realized by a method for generating the object program according to the above operational procedures.

Although the present invention has been fully described by way of examples with reference to the accompanying drawings, it is to be noted that various changes and modifications will be apparent to those skilled in the art.

Therefore, unless such changes and modifications depart from the scope of the present invention, they should be construed as being included therein.

What is claimed is:

1. A program conversion device for converting a source program including a conditional branch into an object program for a computer that is capable of executing at least two instructions in parallel, comprising:
an execution path specifying unit operable to specify an execution path out of a plurality of execution paths in one section of the source program, the section containing the conditional branch and a plurality of branch targets of the conditional branch;
a first code generating unit operable to generate first code corresponding to all instructions in the section;
a second code generating unit operable to generate second code corresponding to a sequence of instructions in the specified execution path, the second code including, as code corresponding to the conditional branch, code that indicates to continue to an instruction which follows the conditional branch in the sequence if a condition for taking the execution path is true, and stop continuing to the instruction if the condition is false;
a third code generating unit operable to generate third code corresponding to instructions in a succeeding section of the source program; and
an object program generating unit operable to generate an object program which causes the computer to execute the first code and the second code in parallel, and execute the third code after the second code if the condition is true and after the first code if the condition is false.

2. The program conversion device of claim 1,
wherein the object program generating unit generates the object program which further causes the computer to stop executing the second code when the first code ends earlier than the second code.

3. The program conversion device of claim 1, further comprising
an execution path obtaining unit operable to obtain, from the computer, information showing an execution path most frequently taken in the section as a result of the computer executing a program which is a substantially direct translation of the source program,
wherein the execution path specifying unit specifies the most frequent execution path.

4. The program conversion device of claim 3, further comprising
a parallel execution limit obtaining unit operable to obtain a number m, the number m being a number of instructions executable in parallel by the computer,
wherein the execution path obtaining unit further obtains, from the computer, information showing execution paths second most to least frequently taken in the section,
the execution path specifying unit further specifies, based on the number m, second to nth most frequent execution paths where n=m−1,
the second code generating unit generates n sets of second code corresponding one-to-one to the most to nth most frequent execution paths specified by the execution path specifying unit, and
the object program generating unit generates the object program which causes the computer to execute the first code and the n sets of second code separately, in parallel.

5. The program conversion device of claim 4,
wherein the object program generating unit generates the object program which further causes the computer to stop the n sets of second code other than a set of second code for which a condition for taking a corresponding execution path is true.

6. The program conversion device of claim 5,
wherein the object program generating unit generates the object program which causes the computer to retain any of the stopped sets of second code without deleting.

7. The program conversion device of claim 1, further comprising
a memory information obtaining unit operable to obtain memory information showing whether the computer is of a memory sharing type where all processor elements in the computer share one memory, or a memory distribution type where the processor elements each have an individual memory,
wherein if the memory information shows the memory sharing type, the object program generating unit generates the object program which further causes processor elements respectively executing the first code and the second code to separately treat a same variable.

8. The program conversion device of claim 1, further comprising
a machine language converting unit operable to convert the object program into a machine language applicable to the computer.

9. A program conversion and execution device for converting a source program including a conditional branch into an object program, the program conversion and execution device being capable of executing at least two instructions in parallel, and comprising:
an execution path specifying unit operable to specify an execution path out of a plurality of execution paths in one section of the source program, the section containing the conditional branch and a plurality of branch targets of the conditional branch;
a first code generating unit operable to generate first-code corresponding to all instructions in the section;
an executing unit operable to execute a program which is a substantially direct translation of the source program, the program including the first code;
an obtaining unit operable to obtain information showing an execution path most frequently taken in the section as a result of the executing unit executing the program, wherein the execution path specifying unit specifies the most frequent execution path;
a second code generating unit operable to generate second code corresponding to a sequence of instructions in the specified execution path, the second code including, as code corresponding to the conditional branch, code that indicates to continue to an instruction which follows the conditional branch in the sequence if a condition for taking the execution path is true, and stop continuing to the instruction if the condition is false;
a third code generating unit operable to generate third code corresponding to instructions in a succeeding section of the source program; and
an object program generating unit operable to generate an object program which causes the executing unit to execute the first code and the second code in parallel, and execute the third code after the second code if the condition is true and after the first code if the condition is false,
wherein the executing unit executes the object program.

10. The program conversion and execution device of claim 9,
wherein the object program generating unit generates the object program which further causes the executing unit to stop executing the second code when the first code ends earlier than the second code.

11. The program conversion and execution device of claim 10, further comprising
a parallel execution limit obtaining unit operable to obtain a number m, the number m being a number of instructions executable in parallel by the program conversion and execution device,
wherein the execution path obtaining unit further obtains information showing execution paths second most to least frequently taken in the section,
the execution path specifying unit further specifies, based on the number m, second to nth most frequent execution paths where n=m−1,
the second code generating unit generates n sets of second code corresponding one-to-one to the most to nth most frequent execution paths specified by the execution path specifying unit, and
the object program generating unit generates the object program which causes the executing unit to execute the first code and the n sets of second code separately, in parallel.

12. The program conversion and execution device of claim 11,
wherein the object program generating unit generates the object program which further causes the executing unit to stop the n sets of second code other than a set of second code for which a condition for taking a corresponding execution path is true.

13. The program conversion and execution device of claim 12,
wherein the object program generating unit generates the object program which causes the executing unit to retain any of the stopped sets of second code without deleting.

14. The program conversion and execution device of claim 9,
wherein if a memory type of the program conversion and execution device is of a memory sharing type where all processor elements in the program conversion and execution device share one memory, the object program generating unit generates the object program which further causes processor elements respectively executing the first code and the second code to separately treat a same variable.

15. A program conversion method for converting a source program including a conditional branch into an object program for a computer that is capable of executing at least two instructions in parallel, comprising:
an execution path specifying step of specifying an execution path out of a plurality of execution paths in one section of the source program, the section containing the conditional branch and a plurality of branch targets of the conditional branch;
a first code generating step of generating first code corresponding to all instructions in the section;
a second code generating step of generating second code corresponding to a sequence of instructions in the specified execution path, the second code including, as code corresponding to the conditional branch, code that indicates to continue to an instruction which follows the conditional branch in the sequence if a condition for taking the execution path is true, and stop continuing to the instruction if the condition is false;
a third code generating step of generating third code corresponding to instructions in a succeeding section of the source program; and
an object program generating step of generating an object program which causes the computer to execute the first code and the second code in parallel, and execute the third code after the second code if the condition is true and after the first code if the condition is false.

16. The program conversion method of claim 15,
wherein the object program generating step generates the object program which further causes the computer to stop executing the second code when the first code ends earlier than the second code.

17. The program conversion method of claim 15, further comprising
an execution path obtaining step of obtaining, from the computer, information showing an execution path most frequently taken in the section as a result of the computer executing a program which is a substantially direct translation of the source program,
wherein the execution path specifying step specifies the most frequent execution path.

18. The program conversion method of claim 17, further comprising
a parallel execution limit obtaining step of obtaining a number m, the number m being a number of instructions executable in parallel by the computer,
wherein the execution path obtaining step further obtains, from the computer, information showing execution paths second most to least frequently taken in the section,
the execution path specifying step further specifies, based on the number m, second to nth most frequent execution paths where n =m−1,
the second code generating step generates n sets of second code corresponding one-to-one to the most to nth most frequent execution paths specified in the execution path specifying step, and
the object program generating step generates the object program which causes the computer to execute the first code and the n sets of second code separately, in parallel.

19. The program conversion method of claim 18,
wherein the object program generating step generates the object program which further causes the computer to stop the n sets of second code other than a set of second code for which a condition for taking a corresponding execution path is true.

20. The program conversion method of claim 19,
wherein the object program generating step generates the object program which causes the computer to retain any of the stopped sets of second code without deleting.

21. The program conversion method of claim 15, further comprising
a memory information obtaining step of obtaining memory information showing whether the computer is of a memory sharing type where all processor elements in the computer share one memory, or a memory distribution type where the processor elements each have an individual memory,
wherein if the memory information shows the memory sharing type, the object program generating step generates the object program which further causes processor elements respectively executing the first code and the second code to separately treat a same variable.

22. The program conversion method of claim 15, further comprising
a machine language converting step of converting the object program into a machine language applicable to the computer.

23. A program conversion and execution method used in a program conversion and execution device for converting a source program including a conditional branch into an object program, the program conversion and execution device being capable of executing at least two instructions in parallel, comprising:
an execution path specifying step of specifying an execution path out of a plurality of execution paths in one section of the source program, the section containing the conditional branch and a plurality of branch targets of the conditional branch;
a first code generating step of generating first code corresponding to all instructions in the section;
an executing step of executing a program which is a substantially direct translation of the source program, the program including the first code;
an obtaining step of obtaining information showing an execution path most frequently taken in the section as a result of executing the program, wherein the execution path specifying step specifies the most frequent execution path;
a second code generating step of generating second code corresponding to a sequence of instructions in the specified execution path, the second code including, as code corresponding to the conditional branch, code that indicates to continue to an instruction which follows the conditional branch in the sequence if a condition for taking the execution path is true, and stop continuing to the instruction if the condition is false;
a third code generating step of generating third code corresponding to instructions in a succeeding section of the source program; and
an object program generating step of generating an object program which causes execution of the first code and the second code in parallel, and execution of the third code after the second code if the condition is true and after the first code if the condition is false,
wherein the executing step executes the object program.

24. The program conversion and execution method of claim 23,
wherein the object program generating step generates the object program which further causes stopping of the execution of the second code when the first code ends earlier than the second code.

25. The program conversion and execution method of claim 24, further comprising
a parallel execution limit obtaining step of obtaining a number m, the number m being a number of instructions executable in parallel by the program conversion and execution device,
wherein the execution path obtaining step further obtains information showing execution paths second most to least frequently taken in the section,
the execution path specifying step further specifies, based on the number m, second to nth most frequent execution paths where n=m−1,
the second code generating step generates n sets of second code corresponding one-to-one to the most to nth most frequent execution paths specified in the execution path specifying step, and
the object program generating step generates the object program which causes execution of the first code and the n sets of second code separately, in parallel.

26. The program conversion and execution method of claim 25,
wherein the object program generating step generates the object program which further causes stopping of the n sets of second code other than a set of second code for which a condition for taking a corresponding execution path is true.

27. The program conversion and execution method of claim 26,
wherein the object program generating step generates the object program which causes retention of any of the stopped sets of second code without deleting.

28. The program conversion and execution method of claim 23,
wherein if a memory type of the program conversion and execution device is of a memory sharing type where all processor elements in the program conversion and execution device share one memory, the object program generating step generates the object program which further causes processor elements respectively executing the first code and the second code to separately treat a same variable.
